(19) United States
(12) Patent Application Publication
(10) Pub. No.: US 2010/0099316 A1
(43) Pub. Date: Apr. 22, 2010

(54) TREATMENT OF TEXTILE

(75) Inventors: Ralf Nörenberg, Ludwigshafen (DE); Sylvia von Krog, Gruenstadt (DE); Wolfram Badura, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/593,830

(22) PCT Filed: Mar. 14, 2008
(86) PCT No.: PCT/EP08/53089

§ 371 Date: Sep. 29, 2009

(30) Foreign Application Priority Data
Mar. 30, 2007 (EP) 07105291.4

(51) Int. Cl. B32B 27/12; C09D 5/00; B32B 27/04

(52) U.S. Cl. 442/93; 524/186; 524/106; 442/83

(57) ABSTRACT

The present invention relates to a process for producing a coated textile, which comprises treating a textile substrate with an aqueous liquor comprising
(A) at least one hydrophobic polymer,
(B) if appropriate at least one condensation product of at least one amino-containing compound and at least one aldehyde or dialdehyde and if appropriate of at least one alcohol,
and thereafter with a further aqueous liquor comprising
(A) at least one hydrophobic polymer,
(B) at least one condensation product of at least one amino-containing compound and at least one aldehyde or dialdehyde and if appropriate of at least one alcohol,
(C) at least one solid in particulate form having an average particle diameter in the range from 1 to 500 nm.

The present invention relates to a process for producing a coated textile, which comprises treating a textile substrate with an aqueous liquor comprising
(A) at least one hydrophobic polymer,
(B) if appropriate at least one condensation product of at least one amino-containing compound and at least one aldehyde or dialdehyde and if appropriate of at least one alcohol,
and thereafter with a further aqueous liquor comprising
(A) at least one hydrophobic polymer,
(B) at least one condensation product of at least one amino-containing compound and at least one aldehyde or dialdehyde and if appropriate of at least one alcohol,
(C) at least one solid in particulate form having an average particle diameter in the range from 1 to 500 nm.

For some years now textile has been coated with particulate entities to improve the soil-repellent properties, see for example EP-A 1 296 283.

WO 02/84013 proposes hydrophobicizing fibers of polyester for example by pulling them through a hot bath of decalin at 80° C. comprising 1% of Aerosil 8200 hydrophobicized silica gel in suspension.

WO 02/84016 proposes hydrophobicizing polyester fabric by pulling it through a bath of hot DMSO (dimethyl sulfoxide) at 50° C. comprising 1% of Aeroperl 8200 hydrophobicized silica gel in suspension.

For either method of hydrophobicization, the solvent is chosen such that the fibers are partially dissolved. This requires the use of large amounts of organic solvent, and that is undesirable in many cases. Moreover, treatment with organic solvents can have an effect on fiber-mechanical properties.

To avoid the use of large amounts of organic solvents, it has been proposed that the textile in question be treated with a preferably aqueous formulation comprising particles dispersed by means of one or more dispersing agents, see for example WO 2004/074568 and WO 2005/113883.

One problem in many cases is to improve particle adhesion to the textile in question because without particle adhesion the soil-repellent effect is not durable.

To improve adhesion, WO 2004/074568 and WO 2005/113883 propose applying a bonding layer, for example by means of a primer. N,N-dimethylol-4,5-dihydroxyethyleneurea (DMDHEU) in particular is proposed as a primer by WO 2004/074568 and WO 2005/113883. This bonding layer shall be applied separately, prior to the application of the particles.

It is an object of the present invention to further improve the existing processes.

We have found that this object is achieved by the process defined at the beginning.

Textiles or else textile materials for the purposes of the present invention are for example fibers, roving, yarn, thread on the one hand and textile fabrics on the other such as for example wovens, knits, nonwovens and garments. Particular preference is given to textile fabrics used for manufacturing outdoor textiles for example. Examples are sails, umbrellas, tarpaulins, groundsheets, tablecloths, awnings and furniture covers for example for chairs, swings or benches.

Textiles for the purposes of the present invention can consist of different materials.

Examples are natural fibers and synthetic fibers and also blend fibers. Examples of natural fibers are silk, wool and cotton. Examples of synthetic fibers are polyamide, polyester, polypropylene, polyacrylonitrile, polyethylene terephthalate, lyocell, polylactic acid (PLA) and viscose. Similarly, modified natural fibers can be coated by the process of the present invention, for example cellulose acetate.

The process of the present invention proceeds from aqueous liquors. Aqueous liquors for the purposes of the present invention are liquors comprising at least 5% by weight of water, based on room temperature volatiles. Preferably, aqueous liquor comprises at least 25% by weight water, more preferably at least 50% by weight and most preferably at least 75% by weight. The maximum water content, based on room temperature volatiles, is 100% by weight, preference being given to 97% by weight, more preferably 95% by weight.

Aqueous liquors used in this invention, as well as water, may comprise organic solvents, examples being methanol, ethanol, isopropanol, acetone, methyl ethyl ketone, methyl isobutyl ketone, ethylene glycol mono-n-butyl ether (butylglycol), ethylene glycol monoisobutyl ether, acetic acid, n-butanol, isobutanol, n-hexanol and isomers, n-octanol and isomers, n-dodecanol and isomers. Organic solvents can account for 0.2-50% by weight and preferably 0.5-35% by weight of the aqueous liquors used according to the present invention. An aqueous liquor having a water content of 100% by weight, based on room temperature volatiles, accordingly comprises no organic solvents.

The process of the present invention is a multistage process. Textile is treated multiply, in particular two times, with a plurality of different aqueous liquors, in particular with altogether two different liquors.

Textile is treated with at least one, preferably with exactly one, aqueous liquor comprising
(A) at least one hydrophobic polymer,
(B) if appropriate at least one condensation product of at least one amino-containing compound and at least one aldehyde or dialdehyde and if appropriate of at least one alcohol.
   The treatment step or steps in question are herein also referred to as first treatment step or first treatment step of the process of the present invention even when a plurality of treatment steps are concerned. The requisite aqueous liquor or liquors is/are accordingly also referred to as first aqueous liquor.

The first aqueous liquor is free of
(C) solid in particulate form having an average particle diameter in the range from 1 to 500 nm, in short solid (C).

Herein “free of solid (C)” is to be understood as meaning that the fraction of solid (C) is less than 0.1 g/l and preferably in the range from 0 to 0.01 g/l of aqueous liquor.

This is followed by treatment with further aqueous liquor comprising
(A) at least one hydrophobic polymer,
(B) at least one condensation product of at least one amino-containing compound and at least one aldehyde or dialdehyde and if appropriate of at least one alcohol,
(C) at least one solid in particulate form having an average particle diameter in the range from 1 to 500 nm.
   The treatment step or steps in question are herein also referred to as second treatment step or second treatment step of the process of the present invention even when a plurality of treatment steps are concerned. The requisite aqueous liquor or liquors is/are accordingly also referred to as second aqueous liquor.

The first aqueous liquor used in the process of the present invention comprises at least one hydrophobic polymer (A).

In one embodiment of the present invention, at least one hydrophobic polymer (A) comprises a polymer or copolymer of ethylenically unsaturated hydrophobic monomers having a solubility in water of less than 1 g/l, determined at 25° C. In copolymers, hydrophobic monomers comprise at least 50% by weight, preferably at least 75% by weight of the copolymer.

Preferred monomers are selected from the groups of the
C₂-C₂₄-olefins, especially a-olefins having 2 to 24 carbon atoms, for example ethylene, propylene, 1-butene, isobutene, 1-hexene, 1-octene, 1-decene, 1-dodecene, 1-hexadecene or 1-octadecene;
vinylaromatics, for example styrene, α-methylstyrene, cis-stilbene, trans-stilbene, diolefins such as for example 1,3-butadiene, cyclopentadiene, chloroprene or isoprene, C₅-C₁₈-cycloolefins such as for example cyclopentene, cyclohexene, norbornene, dimeric cyclopentadiene,
vinyl esters of linear or branched C₁-C₂₀-alkanecarboxylic acids such as for example vinyl acetate, vinyl propionate, vinyl n-butyrate, vinyl n-hexanoate, vinyl n-octanoate, vinyl laurate and vinyl stearate,
(meth)acrylic esters of C₁-C₂₀-alcohols, for example methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl (meth)acrylate, n-octyl (meth)acrylate, n-decyl (meth)acrylate, n-dodecyl (meth)acrylate, n-eicosyl (meth)acrylate
and most preferably from the groups of the halogenated monomers and the monomers having siloxane groups.

Hydrophobic polymers (A) comprising at least one halogenated (co)monomer in interpolymerized form, are herein also referred to as halogenated (co)polymers (A).

Halogenated monomers include chlorinated olefins such as for example vinyl chloride and vinylidene chloride. It is particularly preferable for hydrophobic polymer (A) to comprise a fluorinated (co)polymer.

Most particularly preferred halogenated monomers are fluorous olefins such as for example vinylidene fluoride, trifluorochloroethylene, tetrafluoroethylene, hexafluoropropylene, vinyl esters of fluorinated or perfluorinated C₃-C₁₁-carboxylic acids as described for example in U.S. Pat. No. 2,592,069 and U.S. Pat. No. 2,732,370
(meth)acrylic esters of fluorinated or perfluorinated alcohols such as for example fluorinated or perfluorinated C₃-C₁₄-alkyl alcohols, for example (meth)acrylate esters of HO—CH₂—CH₂—CF₃, HO—CH₂—CH₂—C₂F₅, HO—CH₂—CH₂-n-C₃F₇, HO—CH₂—CH₂-iso-C₃F₇, HO—CH₂—CH₂-n-C₄F₉, HO—CH₂—CH₂-n-C₅F₁₃, HO—CH₂—CH₂-n-C₈F₁₇, HO—CH₂—CH₂-n-C₁₀F₂₁, HO—CH₂—CH₂-n-C₁₂F₂₅,
   described for example in U.S. Pat. No. 2,642,416, U.S. Pat. No. 3,239,557, BR 1,118,007, U.S. Pat. No. 3,462,296.

Similarly, copolymers of for example glycidyl (meth)acrylate with esters of the formula II

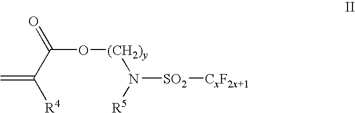

where:
R⁴ is hydrogen, CH₃, C₂H₅,
R⁵ is CH₃, C₂H₅,
x is an integer from 4 to 12 and most preferably from 6 to 8
y is an integer from 1 to 11 and preferably from 1 to 6,
   or glycidyl (meth)acrylate with vinyl esters of fluorinated carboxylic acids are suitable.

Useful copolymers further include copolymers of (meth)acrylic esters of fluorinated or perfluorinated C₃-C₁₂-alkyl alcohols such as for example HO—CH₂—CH₂—CF₃, HO—CH₂—CH₂—C₂F₅, HO—CH₂—CH₂-n-C₃F₇, HO—CH₂—CH₂-iso-C₃F₇, HO—CH₂—CH₂-n-C₄F₉, HO—CH₂—CH₂-n-C₅F₁₁, HO—CH₂—CH₂-n-C₆F₁₃, HO—CH₂—CH₂-n-C₇F₁₅;

with (meth)acrylic esters of nonhalogenated C₁-C₂₀-alcohols, for example methyl (meth)acrylate, ethyl(meth)acrylate, n-butyl(meth)acrylate, n-propyl(meth)acrylate, 2-ethylhexyl(meth)acrylate, n-octyl(meth)acrylate, n-decyl(meth)acrylate, n-dodecyl(meth)acrylate, n-eicosyl(meth)acrylate, or with ethylenically unsaturated carboxylic acids such as methacrylic acid.

An overview of suitable halogenated (co)polymers (B) is given for example in M. Lewin et al., Chemical Processing of Fibers and Fabrics, Part B, Volume 2, Marcel Dekker, New York (1984), pages 172 ff. and pages 178-182.

Further suitable fluorinated polymers are disclosed for example in DE 199 120 810.

From the group of the olefins having siloxane groups there may be mentioned for example olefins of the general formulae III a to III c

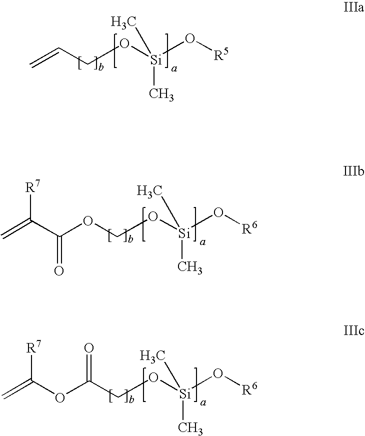

where the variables are defined as follows:
R⁶ is selected from
C₁-C₁₈-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-tetradecyl, n-hexadecyl, n-octadecyl; preferably C₁-C₆-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, more preferably C₁-C₄-alkyl such as methyl, ethyl, n-propyl, isopropyl, n-butyl, isobutyl, sec-butyl and tert-butyl and especially methyl.
C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, more preferably phenyl
C₃-C₁₂-cycloalkyl, for example cyclopropyl, cyclobutyl, cyclopentyl, cyclohexyl, cycloheptyl, cyclooctyl, cyclononyl, cyclodecyl, cycloundecyl and cyclododecyl;
   preference is given to cyclopentyl, cyclohexyl and cycloheptyl or Si(CH₃)₃.

R⁷ is methyl or hydrogen.

a is an integer from 2 to 10 000, especially up to 100,

b is an integer from 0 to 6 and especially from 1 to 2.

When solid (C) (see hereinbelow) comprises an organic polymer, then hydrophobic polymer (A) is other than solid (C), and preferably, hydrophobic polymer (A) is a preferably halogenated polymer (A) and especially a fluorinated polymer.

First aqueous liquor used in the process of the present invention further comprises (B) if appropriate at least one condensation product of at least one amino-containing compound and at least one aldehyde or dialdehyde and if appropriate at least one alcohol,

herein also referred to as “condensation product (B)” for short. Preferably, first aqueous liquor used in the process of the present invention comprises at least one condensation product (B).

Amino-containing compounds comprise organic compounds having at least one, preferably at least two and more preferably exactly two or three primary amino groups per molecule. 1,2-Ethylenediamine and 1,3-propylenediamine are possible examples. Urea is preferred for use as amino-containing compound.

Aldehydes comprise preferably aliphatic aldehydes such as acetaldehyde and particularly formaldehyde.

Dialdehydes comprise preferably aliphatic dialdehydes such as glutaraldehyde, succinaldehyde and particularly glyoxal.

In one embodiment of the present invention, condensation product (B) comprises a compound of the general formula IV.

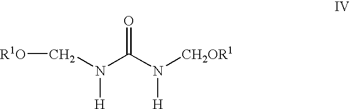

In one embodiment of the present invention, condensation product (C) comprises a compound of the general formula I,

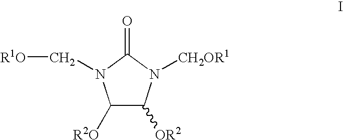

and the variables in formulae I and IV are each defined as follows:
R¹ in either occurrence is different or preferably the same and selected from
   C₁-C₆-alkyl, branched or preferably unbranched, selected from methyl, ethyl, n-propyl, isopropyl, n-butyl, isobutyl, sec-butyl, tert-butyl, n-pentyl, isopentyl, secpentyl, neopentyl, 1,2-dimethylpropyl, isoamyl, n-hexyl, isohexyl, sec-hexyl, more preferably linear C₁-C₄-alkyl such as methyl, ethyl, n-propyl and n-butyl, (CHCH₃—CH₂—O)ₘ—R³, (CH₂—CHCH₃—O)ₘ—R³, (CH₂—CH₂—CH₂—O)ₘ—R³, (CH₂—CH₂—CH₂—CH₂—O)ₘ—R³, preferably (CH₂CH₂O)ₘR³, where m is an integer from 1 to 50,
   and preferably hydrogen.
R² where present is in either occurrence different or preferably the same and selected from
   C₁-C₆-alkyl, branched or preferably unbranched, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, more preferably linear C₁-C₄-alkyl such as methyl, ethyl, n-propyl and n-butyl, (CHCH₃—CH₂—O)ₘ—R³, (CH₂—CHCH₃—O)ₘ—R³, (CH₂—CH₂—CH₂—O)ₘ—R³, (CH₂—CH₂—CH₂—CH₂—O)ₘ—R³, preferably (CH₂CH₂O)ₘR³, where m is an integer from 1 to 50,
   and preferably hydrogen.
R³ is selected from hydrogen and C₁-C₂₀-alkyl, preferably ethyl and particularly methyl.

It is particularly preferable for R¹ and R² to be the same at each occurrence in formula I.

It is very particularly preferred for condensation product (B) to comprise N,N-dimethylol-4,5-dihydroxyethyleneurea (DMDHEU).

The aqueous liquor used in the second treatment step of the process of the present invention comprises at least one hydrophobic polymer (A) and at least one condensation product (B) which are as described above.

The aqueous liquor used in the second treatment step of the process of the present invention further comprises at least one solid in particulate form, herein also called solid (C).

In one embodiment, the fraction of solid (C) is at least 5.5 g/l of aqueous liquor, preferably at least 7 g/l and more preferably at least 10 g/l.

The maximum fraction can be about 150 g/l of aqueous liquor and preferably not more than 25 g/l. Solid (C) can be organic or inorganic in nature, and preferably it is inorganic.

Examples of suitable solids (C) are polyethylene, polypropylene, polyisobutylene and polystyrene and also copolymers thereof with each or one another or with one or more further olefins such as for example styrene, methyl acrylate, ethyl acrylate, methyl (meth)acrylate, butyl acrylate, butyl (meth)acrylate, 2-ethylhexyl acrylate, 2-ethylhexyl (meth)acrylate, maleic anhydride or N-methylmaleimide. A preferred polyethylene or polypropylene is described for example in EP-A 0 761 696.

Particularly suitable solids (C) are inorganic materials, in particular solid inorganic oxides, carbonates, phosphates, silicates or sulfates of groups 3 to 14 of the periodic table of the elements, for example calcium oxide, silicon dioxide or aluminum oxide, calcium carbonate, calcium sulfate or calcium silicate, of which aluminum oxide and silicon dioxide are preferred. Particular preference is given to silicon dioxide in its silica gel form. Fumed silica gels are very particularly preferred. Solid inorganic oxides can be hydrophobicized thermally by heating to 400-800° C. or preferably through physisorbed or chemisorbed organic or organometallic compounds. To this end, particles prior to the coating step are reacted for example with organometallic compounds comprising at least one functional group, for example alkyllithium compounds such as methyllithium, n-butyllithium or n-hexyllithiurn, or silanes such as for example hexamethyldisilazane, octyltrimethoxysilane and in particular halogenated silanes such as methyltrichlorosilane, trimethylchlorosilane or dichlorodimethylsilane.

One embodiment of the present invention utilizes a mixture of hydrophobicized solid inorganic oxide with corresponding nonhydrophobicized solid inorganic oxide, for example in weight fractions of 100:0 to 0:100, preferably 99:1 to 60:40 and more preferably 99:1 to 80:20.

Hydrophobic in connection with the solid or solids (C) is to be understood as meaning that the solubility of solid (C) or solids (C) in water is below 1 g/l and preferably below 0.3 g/l, determined at room temperature.

Solid (C) can have a contact angle of 90° or more with water, determined at room temperature.

Solids (C), when of inorganic material, may preferably be porous in nature. The porous structure is best characterized in terms of the BET surface area, measured to DIN 66131. Utilized solids (A) may preferably have a BET surface area in the range from 5 to 1000 m²/g, preferably in the range from 10 to 800 m²/g and more preferably in the range from 20 to 500 m²/g.

Solid (C) is present in particulate form. The average particle diameter (median value, number average) is at least 1 nm, preferably at least 3 nm and more preferably at least 6 nm. The maximum particle diameter (median value, number average) is 500 nm, preferably 350 nm and more preferably 100 nm. Particle diameter can be measured using commonly used methods such as for example transmission electron microscopy.

In one embodiment of the present invention, at least one solid (C) is present in the form of spherical particles, which is intended to comprehend such solids (C) where at least 75% by weight and preferably at least 90% by weight is present in spherical form and further particles may be present in granular form.

In one embodiment of the present invention, at least one solid (C) can form aggregates and/or agglomerates. When a solid (C) is present in the form of aggregates and/or agglomerates, which can consist of two to several thousand primary particles and which in turn can have a spherical form, the particulars concerning particle form and size relate to primary particles.

The aqueous liquor used in the second treatment step of the process of the present invention comprises one or more hydrophobic polymers which are selected from the polymers enumerated among the hydrophobic polymers (A). This or these hydrophobic polymers (A) are preferably the same as the hydrophobic polymer or polymers (A) used in the first treatment step of the process of the present invention.

The aqueous liquors used in the process of the present invention may comprise one or more surface-active compounds (D) selected for example from the group of the ionic and nonionic emulsifiers.

Nonionic emulsifiers useful as surface-active compounds (D) include for example ethoxylated mono-, di- and trialkylphenols (degree of ethoxylation: 3-50, alkyl radical: C₄-C₁₂) and also ethoxylated fatty alcohols (degree of ethoxylation: 3-80; alkyl radical: C₈-C₃₆). Examples thereof are the Lutensol® grades from BASF Aktiengesellschaft.

Anionic emulsifiers useful as surface-active compounds (D) include for example alkali metal and ammonium salts of alkyl sulfates (alkyl radical: C₈-C₁₂), of sulfuric monoesters of ethoxylated alkanols (degree of ethoxylation: 4-30, alkyl radical: C₁₂-C₁₈) and of ethoxylated alkylphenols (degree of ethoxylation: 3-50, alkyl radical: C₄-C₁₂), of alkylsulfonic acids (alkyl radical: C₁₂-C₁₈) and of alkylarylsulfonic acids (alkyl radical: C₉-C₁₈).

Useful cationic emulsifiers are generally C₆-C₁₈-alkyl-, C₆-C₁₈-aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)ethyl paraffinic acid esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the Gemini surfactant N,N′-(lauryldimethyl)ethylenediamine dibromide. Numerous further examples may be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

Particularly preferred cationic emulsifiers are alkoxylated fatty amines, in particular ethoxylated C₁₀-C₂₀ fatty amines having a degree of ethoxylation in the range of 2 to 12 on average.

Emulsifiers very particularly suitable for use as surface-active compounds (D) include polymeric emulsifiers, for example copolymers of ethylene and at least one α,β-unsaturated mono- or dicarboxylic acid or at least one anhydride of an α,β-unsaturated mono- or dicarboxylic acid, for example acrylic acid, methacrylic acid, crotonic acid, maleic acid, fumaric acid, methylenemalonic acid, maleic anyhdride, itaconic anhydride. The carboxyl groups can be partly or preferably wholly neutralized, for example with alkali metal ions, alkaline earth metal ions, ammonium or amines, for example amines such as triethylamine, diethylamine, ethylamine, trimethylamine, dimethylamine, methylamine, ethyldiisopropylamine, ethanolamine, diethanolamine, triethanolamine, N-methyldiethanolamine, N-(n-butyl)diethanolamine or N,N-dimethylethanolamine.

The fraction of surface-active compound (D) can be chosen within wide limits and can be in the range from 0 to 20 g/l of aqueous liquor, preferably in the range from 0.2 to 10 g/l of aqueous liquor.

In one embodiment of the present invention, the aqueous liquors used in the process of the present invention may comprise one or more additives (E). Suitable are for example wetting agents, defoamers (foam inhibitors), aerating agents, crosslinkers (hardeners), flow assistants and thickening agents and also, in particular polyvinyl acetate, polyvinyl alcohol and partially saponified polyvinyl acetate.

As additive (E) there may be used one or more wetting agents, examples being alkyl-polyglycosides, alkyl phosphonates, alkylphenyl phosphonates, alkyl phosphates and alkylphenyl phosphates.

As additive (E) there can be used one or more defoamers (foam inhibitors), examples being room temperature liquid silicones, nonethoxylated or singly or multiply ethoxylated.

As additive (E) there may be used one or more thickening agents, for example of natural or synthetic origin. Suitable synthetic thickening agents are poly(meth)acrylic compounds, polycarboxylic acids, polyethers, polyimines, polyamides such as for example polyacrylamide, and polyurethanes. Suitable in particular are copolymers with 85% to 95% by weight of acrylic acid, 4% to 15% by weight of acrylamide and about 0.01% to 1% by weight of the (meth)acrylamide derivative of the formula V

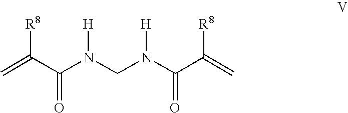

where R⁸ is methyl or preferably hydrogen, with molecular weights M_{w} in the range from 100 000 to 2 000 000 g/mol. Examples of thickening agents of natural origin are agar, carrageenan, modified starch and modified cellulose.

As additive (E) there may be used one or more crosslinkers (hardeners). Examples are isocyanurates and in particular hydrophilicized isocyanurates and also mixed hydrophilicized diisocyanates/isocyanurates, for example hexamethylene diisocyanate (HDI) isocyanurate reacted with C₁-C₄-alkyl polyethylene glycol. Examples of such crosslinkers are known for example from EP-A 0 486 881. Further examples are oxime-capped isocyanates/diisocyanates/isocyanurates, particularly butoxime-capped diisocyanates and butoxime-capped isocyanurates.

As additive (E) there may be used one or more flow assistants, for example ethylene glycol.

As additive (E) there may be used one or more aerating agents, for example one or more Guerbet alcohols, mono- or up to decaethoxylated.

As preferred additive (E) there may be used polyvinyl acetate, polyvinyl alcohol or partially saponified polyvinyl acetate, in particular 0.1 to 75 mol% saponified polyvinyl acetate. Further preferred additives (E) are mixtures of polyvinyl acetate or partially saponified polyvinyl acetate and polyvinyl alcohol.

As additive (E) there may be used weak acids or weak bases as pH regulators. Suitable are for example ammonium salts such as NH₄Cl and (NH₄)₂SO₄. It is also possible to use carboxylic acids such as for example acetic acid or citric acid.

As additive (E) there may be used one or more biocides. Examples of biocides are for example 1,2-benzisothiazolin-3-one (“BIT”) (commercially available as Proxel® brands from Avecia Lim.) and its alkali metal salts, other suitable biocides are 2-methyl-2H-isothiazol-3-one (“MIT”) and 5-chloro-2-methyl-2H-isothiazol-3-one (“CIT”). In general, 10 to 150 ppm of biodide are sufficient, based on the aqueous liquor.

In a preferred embodiment of the present invention, the first aqueous liquor used in the process of the present invention comprises at least one additive (E), most preferably at least one crosslinker.

In one embodiment of the present invention, the first aqueous liquor comprises:
from 2 to 60 g/l and preferably 5 to 40 g/l of hydrophobic polymer (A),
from 0 to 150 g/l and preferably from 40 to 120 g/l of condensation product (B),
less than 0.1 g/l and preferably 0 to 0.01 g/l of solid (C),
0 to 20 g/l and preferably 0.2 to 10 g/l of surface-active compound (D),
altogether 0 to altogether 150 g/l and preferably 5 g/l to 100 g/l of additives (E).

In one embodiment of the present invention, the second aqueous liquor comprises:
from 2 to 60 g/l and preferably 5 to 40 g/l of hydrophobic polymer (A),
from 50 to 150 g/l and preferably from 50 to 120 g/l of condensation product (B),
from 5.5 to 150 g/l and preferably 6 to 25 g/l of solid (C),
0 to 20 g/l and preferably 0.2 to 10 g/l of surface-active compound (D),
altogether 0 to altogether 150 g/l and preferably 25 g/l to 100 g/l of additives (E).

The remainder is for example continuous phase in each case.

The process of the present invention is carried out by treating textile material with the aqueous liquors.

The temperature at which the process of the present invention is carried out is as such not critical. Liquor temperature lies can lie in the range from 10 to 80° C. and preferably in the range from 15 to 60° C.

Wet pickup can be chosen such that the process of the present invention results in a wet pickup of 5% by weight to 85% by weight and preferably 10% to 70% by weight.

The process of the present invention can be carried out in machines commonly used for the finishing of textiles, for example pad-mangles. Suitable are vertical textile feed pad-mangles where the essential element is two rollers in press contact with each other, through which the textile is led. The liquid is filled in above the rollers and wets the textile. The pressure causes the textile to be squeezed off and ensures a constant add-on. Preference is given to pad-mangles having a trough in which the textile is saturated with aqueous liquor and which is followed by a horizontal pair of rollers through which the textile is led. The pressure causes the textile to be squeezed off and ensures a constant add-on.

The treated textile after the treatment according to the present invention can be dried by methods customary in the textile industry.

The treatment according to the present invention can be followed by thermal treatment, which can be operated continuously or batchwise. The duration of the thermal treatment can be chosen within wide limits. The thermal treatment can typically be carried out for a duration of about 10 seconds to about 30 minutes and especially 30 seconds to 5 minutes. A thermal treatment is carried out by heating to temperatures up to 180° C. and preferably up to 150° C. It is of course necessary to adapt the temperature of the thermal treatment to the sensitivity of the fabric.

An example of a suitable method of thermal treatment is hot air drying.

The process of the present invention provides an improved wet pickup in many cases.

The present invention further provides textiles coated by the process of the present invention, hereinafter also known as inventive textiles. In inventive textiles, the coating is disposed in one layer. Inventive textiles are notable not only for good fastnesses such as for example rubfastnesses, but also for very good soil repellency, low permeability to water and also high stiffness and low permeability to water. Inventive textiles are particularly useful for producing textiles for the outdoor sector, for example for parasols and awnings, but also for covering furniture.

The present invention further provides for the use of inventive textiles as or for producing awnings, hoods or tarpaulins. The present invention further provides awnings, hoods or tarpaulins produced using inventive textiles.

The present invention further provides aqueous liquors comprising
(A) at least one hydrophobic polymer,
(B) preferably at least one condensation product of at least one amino-containing compound and at least one aldehyde or dialdehyde and if appropriate of at least one alcohol, also referred to as condensation product (B) for short,
(D) if appropriate at least one surface-active compound, also called surface-active compound (D) for short,
(E) preferably one or more additives,
   and free of
(C) solid in particulate form having an average particle diameter in the range from 1 to 500 nm, also called solid (C) for short.

Hydrophobic polymer (A), condensation product (B), surface-active compound (D) and additives (E) and also solid (C) are defined above.

In one embodiment of the present invention, condensation product (B) comprises a condensation product of urea and at least one aldehyde or dialdehyde and if appropriate at least one alcohol.

In one embodiment of the present invention the hydrophobic polymer (A) comprises a fluorinated (co)polymer.

In one embodiment of the present invention, condensation product (B) comprises a compound of the general formula IV.

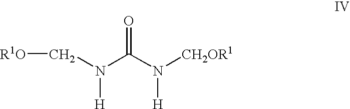

In one embodiment of the present invention, condensation product (B) comprises a compound of the general formula I

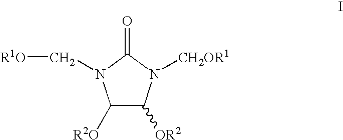

where the variables in formulae I and IV are defined as follows:
R¹ in either occurrence is the same or different and selected from hydrogen, C₁-C₆-alkyl,
   (CHCH₃—CH₂—O)ₘ—R³, (CH₂—CHCH₃—O)ₘ—R³, (CH₂—CH₂—CH₂—O)ₘ—R³,
   (CH₂—CH₂—CH₂—CH₂—O)ₘ—R³ and preferably (CH₂CH₂O)ₘ—R³, where m is an integer from 1 to 50,
R² in either occurrence is the same or different and selected from hydrogen, C₁-C₆-alkyl,
   (CHCH₃—CH₂—O)ₘ—R³, (CH₂—CHCH₃—O)ₘ—R³, (CH₂—CH₂—CH₂—O)ₘ—R³,
   (CH₂—CH₂—CH₂—CH₂—O)ₘ—R³ and preferably (CH₂CH₂O)ₘ—R³, where m is an integer from 1 to 50,
R³ is selected from hydrogen and C₁-C₂₀-alkyl.

In one embodiment of the present invention, the inventive aqueous liquor comprises:
from 2 to 60 g/l and preferably 5 to 40 g/l of hydrophobic polymer (A),
from 0 to 150 g/l and preferably 40 to 120 g/l of condensation product (B),
0 to 20 g/l and preferably 0.2 to 10 g/l of surface-active compound (D),
altogether 0 to altogether 150 g/l and preferably 25 to 100 g/l of additives (E),
and less than 0.1 g/l, preferably 0 to 0.01 g/l of solid (C).

It is particularly preferable for inventive aqueous liquors to comprise at least one additive (E), most preferably at least one crosslinker.

In one embodiment of the present invention, inventive liquors have a pH in the range from 2 to 9, preferably 3.5 to 7.5.

The inventive liquor is particularly useful in the process of the present invention, as a first liquor.

The present invention further provides a process for producing inventive aqueous liquors, herein also called inventive production process. The inventive production process can be carried out by mixing the components, hydrophobic polymer (A), condensation product (B) and if appropriate surface-active compound (D) and if appropriate one or more additives (E) with each or one another and with water, for example by stirring. The order of the components, hydrophobic polymer (A), condensation product (B) and if appropriate surface-active compound (D) and if appropriate one or more additives (E) is discretional. However, it is preferable that one or more of the components, in particular hydrophobic polymer (A) and condensation product (B), be used in the form of a premix with water or a solvent.

The inventive production process can be carried out at any desired temperatures, in particular temperatures in the range from 5 to 95° C. Room temperature is preferred.

Working examples elucidate the invention.

Amounts given for aqueous mixtures are always based on the solids content, unless expressly stated otherwise

I. Production of inventive aqueous liquors

The following substances were used:

Hydrophobic polymer (A.1): aqueous dispersion (30% by weight solids content) of a random copolymer formed from 10% by weight of methacrylic acid and 90% by weight of CH₂═C(CH₃)COO—CH₂—CH₂-n-C₈F₁₇ with Mₙ 3500 g/mol (gel permeation chromatography)

Condensation product (B.1): compound I.1 (DMDHEU)

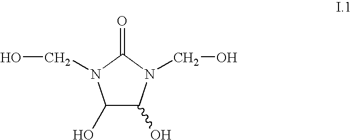

Condensation product (B.2): compound I.2

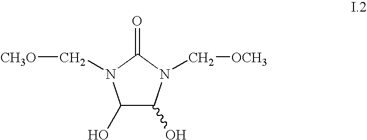

Solid (C.1): dimethylsiloxane-modified fumed silica having a BET surface area of 225 m²/g, determined to DIN 66131, primary particle diameter: 10 nm (median value, number average).

(D.1): n-C₁₂H₂₅—N(CH₂CH₂—O——CH₂CH₂—OH)₂

(D.2): iso-C₁₀H₂₁(OCH₂CH₂)₅OH

(E.1): 45% by weight aqueous dispersion of partially saponified polyvinyl acetate, T_{g}: 33° C.,

(E.2) 60% by weight solution of trimeric hexamethylene diisocyanate in propylene glycol (30% by weight) and n-C₁₈H₃₇(OCH₂CH₂)₁₅OH (10% by weight)

(E.3): polyacrylamide

HOAc: 60% by weight aqueous acetic acid

Butylglyk.: Ethylene glycol n-butyl ether (butylglycol)

General procedure:

The components as per table 1 were mixed and made up with water to one liter to obtain the first aqueous liquors WF1.2 to WF1.4 (each inventive), which were used for treating textile substrates, or V-WF.1, which is an aqueous liquor for a comparative test.

Further, the components as per table 2 were mixed to obtain second aqueous liquors WF2.1 to WF2.4, which were used for treating textile substrates.

TABLE 1
Composition of first aqueous liquors

| Component | | V-WF1.1 | WF1.2 | WF1.3 | WF1.4 |
|---|---|---|---|---|---|
| (A.1) | [g/l] | 0 | 8 | 5 | 9 |
| (B.1) | [g/l] | 49 | 49 | 49 | 49 |
| (E.1) | [g/l] | 31 | 31 | 31 | 31 |

TABLE 2
Composition of second aqueous liquors

| Component | | WF2.1 | WF2.2 | WF2.3 | WF2.4 |
|---|---|---|---|---|---|
| (A.1) | [g/l] | 40 | 40 | 40 | 40 |
| (B.1) | [g/l] | 15 | 15 | 15 | 15 |
| (B.2) | [g/l] | 30 | 30 | 30 | 30 |
| (C.1) | [g/l] | 40 | 40 | 40 | 40 |
| (D.1) | [g/l] | 5 | 5 | 5 | 5 |
| (D.2) | [g/l] | 2 | 2 | 2 | 2 |
| (E.1) | [g/l] | 0 | 0 | 0 | 0 |
| (E.2) | [g/l] | 0 | 0 | 0 | 0 |
| (E.3) | [g/l] | 0.4 | 0.4 | 0.4 | 0.4 |
| NH₄Cl | [g/l] | 30 | 30 | 30 | 30 |
| HOAc | [g/l] | 6 | 6 | 6 | 6 |
| Butylglyk. | [g/l] | — | — | — | — |

General procedure for inventive treatment of textile substrates as exemplified for woven polyester fabric:
A woven polyester fabric having a basis weight of 220 g/m² was treated with an inventive aqueous liquor as per table 1 on a pad-mangle from Mathis (model HVF12085). The squeeze pressure of the rolls was 4 bar. This produced a wet pickup of 30%. Application speed was 10 m/min. The treated polyester fabric was subsequently dried on a tenter at 120° C. for one minute. The subsequent thermal treatment took one minute at 185° C. with circulating air. Thereafter, the fabric was treated with a second aqueous liquor as per table 2 on a pad-mangle from Mathis (model HVF12085). The squeeze pressure of the rolls was 4 bar. This produced a wet pickup of 22% (WF2.1) or 11% (WF2.2 to WF2.4). Application speed was 10 m/min. The treated polyester fabric was subsequently dried on a tenter at 120° C. for one minute. The subsequent thermal treatment took one minute at 185° C. with circulating air. This gave inventive treated polyester fabrics PES.2 to PES.4 and comparative polyester fabric V-PES.1.

Performance properties are revealed in table 3.

TABLE 3
Performance properties of inventively treated polyester fabrics
PES.2 to PES.4 and comparative polyester fabric V-PES.1.

| | Liquors used | | | |
|---|---|---|---|---|
| | WF1.1 | WF1.2 | WF1.3 | WF1.4 |
| | WF2.1 | WF2.2 | WF2.3 | WF2.4 |
| Textile obtained | V-PES.1 | PES.2 | PES.3 | PES.4 |
| Dynamic rolloff angle [°] | 11 | 13 | 13 | 13 |
| Beadoff effect | 4 | 5 | 4 | 3 |
| Water absorption [%] | 8.3 | 7.0 | 9.4 | 8.2 |
| Permeation [ml] | 0 | 0 | 0 | 0 |
| Hydrohead [mm] | 450 | 450 | 460 | 460 |
| Honey test | ++ | ++ | ++ | ++ |

Determination of dynamic rolloff angle:

The textile sample which has been treated according to the present invention and is to be tested was manually tensioned and fixed with nails to a flat wooden board whose inclination was continuously adjustable in the range from 1° to 90°. A cannula was then used to drop individual water droplets onto the textile sample from a height of 10 mm. The droplets had a mass of 4.7 mg. The angle of inclination was incrementally decreased to that angle of inclination at which the droplets were just starting to be beaded off and there was no sign of adhesion. The results are given in Table 2.

Beadoff effect, (water) absorption and permeation (water permeability) are each based on water. Water absorption was tested according to Bundesmann, DIN 53888.

Hydrohead was determined to DIN EN 20811.

The honey test was carried out by pipetting fresh woodland honey from a height of 5 cm onto inventive textile-clamped at an angle of 20° . The honey behaved as evident from the table, where:
++ indicates that it runs off in round droplets without leaving residue,
+ indicates that it runs off, forming a small tear as it runs
0 indicates that it runs off, forming a visible tear as it runs
− indicates that it has a wetting effect

1. A process comprising treating a textile substrate with an aqueous liquor comprising
(A) at least one hydrophobic polymer,
(B) optionally at least one condensation product of at least one amino-containing compound, at least one aldehyde or dialdehyde and optionally at least one alcohol,
and thereafter with a further aqueous liquor comprising
(A) at least one hydrophobic polymer,
(B) at least one condensation product of at least one amino-containing compound, at least one aldehyde or dialdehyde and optionally at least one alcohol,
(C) at least one solid in particulate form having an average particle diameter in the range from 1 to 500 nm.

2. The process according to claim 1 wherein said condensation product (B) comprises a condensation product of urea, at least one aldehyde or dialdehyde and optionally at least one alcohol.

3. The process according to claim 1 wherein said hydrophobic polymer (A) comprises a fluorinated (co)polymer.

4. The process according to claim 1 wherein a thermal treatment is carried out following the treatment with aqueous liquors.

5. The process according to claim 1 wherein said condensation product (B) comprises a compound of the general formula I 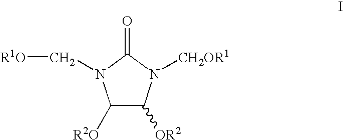
where the variables are defined as follows:
R¹ in either occurrence is the same or different and selected from the group consisting of hydrogen, C₁-C₆-alkyl, (CHCH₃—CH₂—O)ₘ—R³, (CH₂—CHCH₃—O)ₘ—R³,
(CH₂—CH₂—CH₂—CH₂—O)_{m——R}³ and (CH₂CH₂O)ₘ—R³, where m is an integer in the range from 1 to 50,
R² in either occurrence is the same or different and selected from the group consisting of hydrogen, C₁-C₆-alkyl, (CHCH₃—CH₂—O)ₘ—R³, (CH₂—CHCH₃—O)ₘ—R³, (CH₂—CH₂—CH₂—CH₂—O)ₘ—R³ and (CH₂CH₂O)ₘR³, where m is an integer in the range from 1 to 50,
R³ is hydrogen or C₁-C₂₀-alkyl.

6. The process according to claim 1 wherein said further aqueous liquor comprises at least one surface-active compound (D).

7. The process according to claim 1 wherein the first aqueous liquor or a further aqueous liquor comprises at least one additive (E) selected from the group consisting of wetting agents, defoamers (foam inhibitors), aerating agents, crosslinkers (hardeners), flow assistants and thickening agents, polyvinyl acetate, polyvinyl alcohol and partially saponified polyvinyl acetate.

8. A textile treated by a process according to claim 1.

9. (canceled)

10. An awning, hood or tarpaulin comprising a textile according to claim 8.

11. An aqueous liquor comprising
(A) at least one hydrophobic polymer,
(B) at least one condensation product of at least one amino-containing compound at least one aldehyde or dialdehyde and optionally at least one alcohol,
(E) at least one additive selected from the group consisting of wetting agents, defoamers (foam inhibitors), aerating agents, crosslinkers (hardeners), flow assistants and thickening agents, polyvinyl acetate, polyvinyl alcohol and partially saponified polyvinyl acetate,
and free of
(C) solid in particulate form having an average particle diameter in the range from 1 to 500 nm.

12. The aqueous liquor according to claim 11 wherein said condensation product (B) comprises a condensation product of urea, at least one aldehyde or dialdehyde and optionally at least one alcohol.

13. The aqueous liquor according to claim 11 wherein said hydrophobic polymer (A) comprises a fluorinated (co)polymer.

14. The aqueous liquor according to claim 11 wherein said condensation product (B) comprises a compound of the general formula I 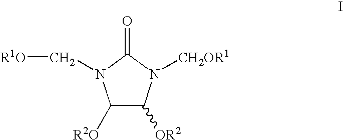
where:
R¹ in either occurrence is the same or different and selected from the group consisting of hydrogen, C₁-C₆-alkyl, (CHCH₃—CH₂—O)ₘ—R³, (CH₂—CHCH₃—O)ₘ—R³,
(CH₂—CH₂—CH₂—CH₂—O)ₘ—R³ and (CH₂CH₂O)ₘR³, where m is an integer in the range from 1 to 50,
R² in either occurrence is the same or different and selected from the group consisting of hydrogen, C₁-C₆-alkyl, (CHCH₃—CH₂—O)ₘ—R³, (CH₂—CHCH₃—O)ₘ—R³,
(CH₂—CH₂—CH₂—CH₂—O)ₘ—R³ and (CH₂CH₂O)ₘR³, where m is an integer in the ranges from 1 to 50,
R³ is hydrogen or C₁-Cₘ-alkyl.
